(19) United States
(12) Patent Application Publication
(10) Pub. No.: US 2009/0269270 A1
(43) Pub. Date: Oct. 29, 2009

(54) PROCESS FOR PREPARING CHLORINE IN A FLUIDIZED-BED REACTOR

(75) Inventors: Lothar Seidemann, Mannheim (DE); Martin Karches, Neustadt (DE); Dieter Stuetzer, Dudenhofen (DE); Martin Sesing, Waldsee (DE); Olga Schubert, Ludwigshafen (DE); Heiko Urtel, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/441,659

(22) PCT Filed: Sep. 19, 2007
(86) PCT No.: PCT/EP2007/059870

§ 371 Date: Mar. 17, 2009

(30) Foreign Application Priority Data
Sep. 19, 2006 (EP) 06120886.4

(51) Int. Cl. C01B 7/04

(52) U.S. Cl. 423/502

(57) ABSTRACT

A process for preparing chlorine in a fluidized-bed reactor, in which a gaseous reaction mixture comprising hydrogen chloride and oxygen flows from the bottom upward through a heterogeneous particulate catalyst forming a fluidized bed, wherein the fluidized bed is provided with internals which divide the fluidized bed into a plurality of cells arranged horizontally in the fluidized-bed reactor and a plurality of cells arranged vertically in the fluidized-bed reactor, with the cells having cell walls which are permeable to gas and have openings which ensure an exchange number of the heterogeneous, particulate catalyst in the vertical direction in the range from 1 to 100 liters/hour per liter of reactor volume, is proposed.

The invention relates to a process for preparing chlorine by the Deacon process in a fluidized-bed reactor, in which a gaseous reaction mixture comprising hydrogen chloride and oxygen is passed from the bottom upward over a heterogeneous, particulate catalyst forming a fluidized bed.

The Deacon process is, as is known, the process for preparing chlorine by oxidation of hydrogen chloride by means of oxygen which was filed as a patent by the English chemist Henry Deacon in 1868. The reaction is exothermic, with an enthalpy of reaction of −114.8 kJ/mol, and is an equilibrium reaction, i.e. the reaction does not proceed to completion, with the equilibrium conversion decreasing with rising temperature. However, to ensure a sufficiently high reaction rate for industrial applications, it is necessary to increase the reaction temperature to at least 450° C. However, the copper-based catalysts found by Deacon are not stable at these temperatures.

There have been numerous further developments, in particular with regard to catalysts having a higher activity at the lowest possible temperature. These include, for example, catalysts which are based on chromium and are obtained by calcination of a compound which is in turn obtained by reaction of chromium nitrate, chromium chloride and the chromium salt of an organic acid with ammonia or by calcination of the mixture of the compound and a silicon compound, preferably at a temperature below 800° C., as described in U.S. Pat. No. 4,828,815.

Other catalysts which are effective at low temperatures are based on ruthenium compounds, in particular ruthenium chloride, preferably on a support, as described, for example, in GB-B 1,046,313. Further ruthenium-based catalysts for the Deacon process are supported ruthenium oxide catalysts or supported catalysts of the ruthenium mixed oxide type, in which the content of ruthenium oxide is from 0.1 to 20% by weight and the mean particle diameter of ruthenium oxide is from 1.0 to 10.0 nm, corresponding to DE-A 197 48 299.

The use of a fluidized-bed reactor for carrying out the Deacon reaction using supported copper compounds as catalyst is described in J. T. Quant et al.: The Shell Chlorine Process, which appeared in The Chemical Engineer, July/August 1963, pages CE 224-CE 232.

In view of the above, it was an object of the invention to provide a process for carrying out the Deacon process in a fluidized-bed reactor, by means of which improved yield and selectivity can be achieved.

The object is achieved by a process for preparing chlorine in a fluidized-bed reactor, in which a gaseous reaction mixture comprising hydrogen chloride and oxygen flows from the bottom upward through a heterogeneous particulate catalyst forming a fluidized bed, wherein the fluidized bed is provided with internals which divide the fluidized bed into a plurality of cells arranged horizontally in the fluidized-bed reactor and a plurality of cells arranged vertically in the fluidized-bed reactor, with the cells having cell walls which are permeable to gas and have openings which ensure an exchange number of the heterogeneous, particulate catalyst in the vertical direction in the range from 1 to 100 liters/hour per liter of reactor volume.

The fluidized-bed reactor used according to the invention has improved internals, in particular in respect of the residence time properties, with the heterogeneous particulate catalyst residing locally for significantly longer, by about 2 orders of ten or longer compared to the gas flow. As a result, mass transfer is improved and the conversion is thus increased.

It has been found that it is important to divide the fluidized bed into cells, i.e. hollow spaces enclosed by cell walls, by means of internals both in the horizontal direction and in the vertical direction, with the cell walls being permeable to gas and having openings which allow solids exchange in the vertical direction in the fluidized-bed reactor. Furthermore, the cell walls can be provided with openings which allow solids exchange in the horizontal direction. The heterogeneous particulate catalyst can thus move in the vertical direction and possibly also in the horizontal direction through the fluidized-bed reactor, but is held back in the individual cells compared to a fluidized bed without these, with the above-defined exchange numbers being ensured.

The exchange number is determined by the use of radioactively labeled solid tracer particles which are introduced into the fluidized reaction system, as described, for example, in: G. Reed “Radioisotope techniques for problem-solving in industrial process plants”, Chapter 9 (“Measurement of residence times and residence-time distribution”), p. 112-137, (J. S. Charlton, ed.), Leonard Hill, Glasgow and London 1986, (ISBN 0-249-44171-3). Recording of the time and location of these radioactively labeled particles enables the solids motion to be determined locally and the exchange number to be derived (G. Reed in: “Radioisotope techniques for problem-solving in industrial process plants”, Chapter 11 (“Miscellaneous radiotracer applications”, 11.1. “Mixing and blending studies”), p. 167-176, (J. S. Charlton, ed.), Leonard Hill, Glasgow and London 1986, (ISBN 0-249-44171-3).

Targeted selection of the geometry of the cells enables the residence time of the heterogeneous particulate catalyst in these to be matched to the characteristics of the reaction to be carried out in the particular case.

The series arrangement of a plurality of cells, i.e., in particular from 0 to 100 cells or else from 10 to 50 cells, per meter of bed height, i.e. in the vertical direction in the direction of gas flow from the bottom upward through the reactor, limits backmixing and thus improves the selectivity and the conversion. The additional arrangement of a plurality of cells, i.e. from 10 to 100 cells or else from 10 to 50 cells, per meter in the horizontal direction in the fluidized-bed reactor, i.e. cells through which the reaction mixture flows in parallel or in series, allows the capacity of the reactor to be matched to requirements. The capacity of the reactor of the invention is thus not limited and can be matched to specific requirements, for example for reactions on an industrial scale.

As a result of the cells enclosing hollow spaces which accommodate the particulate heterogeneous catalyst, the cell material itself takes up only a limited part of the cross section of the fluidized-bed reactor, in particular only from about 1 to 10% of the cross-sectional area of the fluidized-bed reactor, and therefore does not lead to the disadvantages associated with increased occupation of the cross section which are known in the case of the internals from the prior art.

The fluidized-bed reactor used in the process of the invention is, as is customary, supplied with the gaseous starting materials from the bottom via a gas distributor. On passing through the reaction zone, the gaseous starting materials are partially reacted over the heterogeneous particulate catalyst which is fluidized by the gas flow. The partially reacted starting materials flow into the next cell where they undergo a further partial reaction.

Above the reaction zone, there is a solids separation device which separates the entrained catalyst from the gas phase. The reacted product leaves the fluidized-bed reactor according to the invention at its upper end in solids-free form.

In addition, the fluidized-bed reactor used according to the invention can be additionally supplied with liquid starting materials either from the bottom or from the side. However, these have to be able to vaporize immediately at the point where they are introduced in order to ensure the fluidizability of the catalyst.

As catalysts, it is possible to use the known heterogeneous, particulate, supported or unsupported catalysts for the Deacon process, in particular catalysts comprising one or more ruthenium, copper or chromium compounds.

The geometry of the cells is not restricted; the cells can be, for example, cells having round walls, in particular hollow spheres, or cells having angular walls. If the walls are angular, the cells preferably have no more than 50 corners, preferably no more than 30 corners and in particular no more than 10 corners.

The cell walls in the cells of the internals are permeable to gas so as to ensure fluidization of the heterogeneous particulate catalyst as a result of flow of the gas phase through the cells. For this purpose, the cell walls can be made of a woven mesh or else of sheet-like materials which have, for example, round holes or holes of another shape.

Here, the mean mesh opening of the woven meshes used or the preferred width of the holes in the cell walls is, in particular, from 50 to 1 mm, more preferably from 10 to 1 mm and particularly preferably from 5 to 1 mm.

As internals in the fluidized bed, particular preference is given to using cross-channel packings, i.e. packings having creased gas-permeable metal sheets, expanded metal sheets or woven meshes which are arranged in parallel to one another in the vertical direction in the fluidized-bed reactor and have creases which form flat areas between the creases having an angle of inclination to the vertical which is different from zero, with the flat areas between the creases of successive metal sheets, expanded metal sheets or woven meshes having the same angle of inclination but with the opposite sign so as to form cells which are delimited in the vertical direction by constrictions between the creases.

Examples of cross-channel packings are the packings of the types Mellpacke®, CY or BX from Sulzer AG, CH-8404 Winterthur, or the types A3, BSH, B1 or M from Monz GmbH, D-40723 Hilden.

In the cross-channel packings, hollow spaces, i.e. cells, delimited by constrictions between the creases are formed in the vertical direction between two successive metal sheets, expanded metal sheets or woven meshes as a result of the creased structure of these.

The mean hydraulic diameter of the cells, determined by means of the radioactive tracer technique which is, for example, described above in the reference cited in connection with the determination of the exchange number, is preferably in the range from 500 to 1 mm, more preferably from 100 to 5 mm and particularly preferably from 50 to 5 mm.

Here, the hydraulic diameter is defined in a known manner as four times the horizontal cross-sectional area of the cell divided by the circumference of the cell viewed from above.

The mean height of the cells, measured in the vertical direction in the fluidized-bed reactor by means of the radioactive tracer technique, is preferably from 100 to 1 mm, more preferably from 100 to 3 mm and particularly preferably from 40 to 5 mm.

The above cross-channel packings occupy only a small part of the cross-sectional area of the fluidized-bed reactor, in particular a proportion of from about 1 to 10% of this.

The angles of inclination to the vertical of the flat areas between the creases are preferably in the range from 10 to 80°, in particular from 20 to 70°, particularly preferably from 30 to 60°.

The flat areas between the creases in the metal sheets, expanded metal sheets or woven meshes preferably have a crease height in the range from 100 to 3 mm, particularly preferably from 40 to 5 mm, and a spacing of the constrictions between the creases in the range from 50 to 2 mm, particularly preferably from 20 to 3 mm.

In order to achieve targeted control of the reaction temperature, heat exchangers can be installed in the internals forming the cells for the purpose of introducing heat in the case of endothermic reactions or removing heat in the case of exothermic reactions. The heat exchangers can, for example, be configured in the form of plates or tubes and be arranged vertically, horizontally or in an inclined fashion in the fluidized-bed reactor.

The heat transfer areas can be matched to the specific reaction; in this way, any reaction can be implemented in heat engineering terms by means of the reactor concept according to the invention.

The internals forming the cells are preferably made of materials having a very good thermal conductivity so that heat transport via the cell walls is not hindered. The heat transfer properties of the reactor according to the invention thus correspond to those of a conventional fluidized-bed reactor.

The materials for the internals forming the cells should also have a sufficient stability under reaction conditions; in particular, not only the resistance to chemical and thermal stresses but also the resistance of the material to mechanical attack by the fluidized catalyst have to be taken into account.

Owing to the ease of working them, metal, ceramic, polymers or glass materials are particularly useful.

The internals are preferably configured so that they divide from 10 to 90% by volume of the fluidized bed into cells.

Here, the lower region of the fluidized bed in the flow direction of the gaseous reaction mixture is preferably free of internals.

The internals which divide the fluidized bed into cells are particularly preferably located above the heat exchangers. This enables, in particular, the residue conversion to be increased.

As a result of the limited occupation of the cross section by the internals forming the cells, the reactor according to the invention does not have any disadvantages in respect of demixing and discharge tendency of the fluidized particulate catalyst.

The invention is illustrated below with the aid of a drawing.

In the drawing:

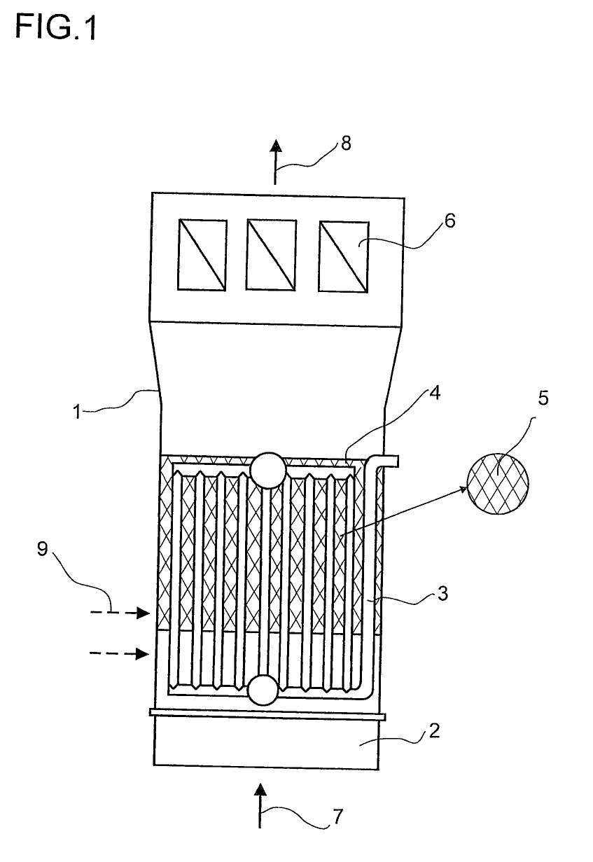

FIG. 1 schematically shows a preferred embodiment of a fluidized-bed reactor used according to the invention, and

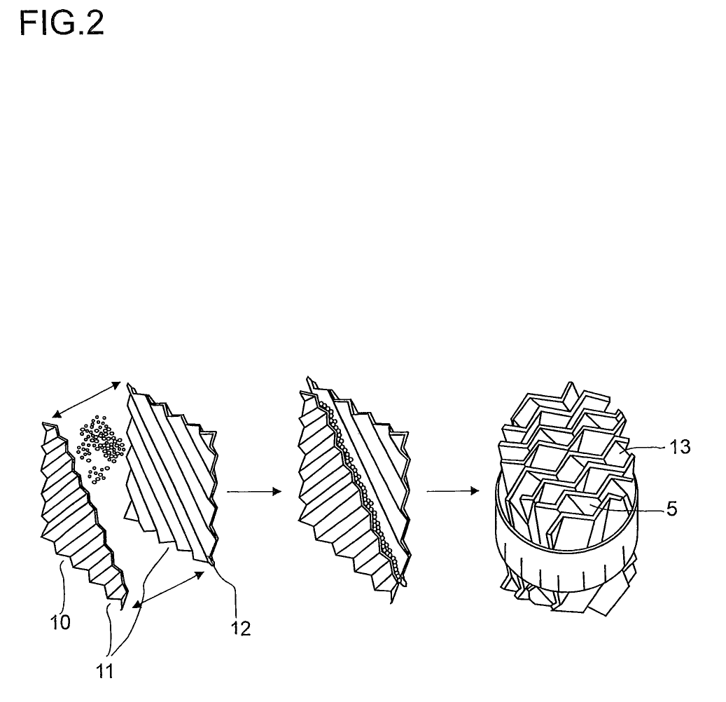

FIG. 2 schematically shows a preferred embodiment of internals used according to the invention.

The fluidized-bed reactor 1 shown in FIG. 1 comprises a solids-free gas distributor zone 2, internals 3 which form cells 4 and a heat exchanger 5 in the region of the internals 3.

Above the reaction zone, the reactor widens and has at least one solids separator 6. The arrow 7 indicates the introduction of the gaseous starting materials and the arrow 8 indicates the discharge of the gaseous product stream. Additional liquid-phase starting materials can be introduced at the side, via the broken-line arrows 9.

FIG. 2 shows a preferred embodiment of internals 3 according to the invention in the form of a cross-channel packing having creased metal sheets 10 which are arranged parallel to one another in the longitudinal direction and have creases 11 which divide the metal sheet 10 into flat areas 12 between the creases, with two successive metal sheets being arranged so that they have the same angle of inclination but with the opposite sign and thus form cells 4 which are delimited in the vertical direction by constrictions 13.

1-16. (canceled)

17. A process for preparing chlorine in a fluidized-bed reactor, in which a gaseous reaction mixture comprising hydrogen chloride and oxygen flows from the bottom upward through a heterogeneous particulate catalyst forming a fluidized bed, wherein the fluidized bed is provided with internals which divide the fluidized bed into a plurality of cells arranged horizontally in the fluidized-bed reactor and a plurality of cells arranged vertically in the fluidized-bed reactor, with the cells having cell walls which are permeable to gas and have openings which ensure an exchange number of the heterogeneous, particulate catalyst in the vertical direction in the range from 1 to 100 liters/hour per liter of reactor volume, and wherein the internals are configured as cross-channel packing having creased gas permeable metal sheets, expanded metal sheets or woven meshes which are arranged in parallel to one another in the vertical direction in the fluidized-bed reactor and have creases which form flat areas between the creases having an angle of inclination to the vertical which is different from zero, with the flat areas between the creases of successive metal sheets, expanded metal sheets or woven meshes having the same angle of inclination but with the opposite sign so as to form cells which are delimited in the vertical direction by constrictions between the creases.

18. The process according to claim 17, wherein a supported or unsupported catalyst comprising one or more ruthenium, copper or chromium compounds is used as heterogeneous particulate catalyst.

19. The process according to claim 17, wherein the openings in the cell walls of the cells arranged in the fluidized-bed reactor ensure an exchange number of the heterogeneous particulate catalyst in the vertical direction in the range from 10 to 50 liters/hour per liter of reactor volume and in the horizontal direction of zero or from 10 to 50 liters/hour per liter of reactor volume.

20. The process according to claim 17, wherein the angle of inclination to the vertical of the flat areas between the creases is in the range from 10 to 80°.

21. The process according to claim 17, wherein the cells of the internals have a hydraulic diameter measured by means of the radioactive tracer technique of from 100 to 5 mm.

22. The process according to claim 17, wherein the cells of the internals have a mean height measured in the vertical direction in the fluidized-bed reactor by means of the radioactive tracer technique of from 100 to 3 mm.

23. The process according to claim 17, wherein the flat areas between the creases in the metal sheets, expanded metal sheets or woven meshes have a crease height in the range from 100 to 3 mm, and the spacing of the constrictions between the creases is in the range from 50 to 2 mm.

24. The process according to claim 17, wherein heat exchangers are installed in the internals.

25. The process according to claim 24, wherein the heat exchangers are configured in the form of plates or tubes.

26. The process according to claim 17, wherein the internals are made of metal, ceramic, polymer or glass materials.

27. The process according to claim 17, wherein the internals divide from 10 to 90% by 20 volume of the fluidized bed into cells.

28. The process according to claim 27, wherein the lower region of the fluidized bed in the flow direction of the gaseous reaction mixture is free of internals.

29. The process according to claim 24, wherein the internals which divide the fluidized bed into cells are located above the heat exchangers.

30. The process according to claim 20, wherein the angle of inclination to the vertical of the flat areas between the creases is in the range from 20 to 70°.

31. The process according to claim 22, wherein the cells of the internals have a mean height measured in the vertical direction in the fluidized-bed reactor by means of the radioactive tracer technique of from 40 to 5 mm.

32. The process according to claim 23, wherein the flat areas between the creases in the metal sheets, expanded metal sheets or woven meshes have a crease height in the range from 40 to 5 mm, and the spacing of the constrictions between the creases is in the range from 20 to 3 mm.
